(19) United States
(12) Patent Application Publication
(10) Pub. No.: US 2006/0268863 A1
(43) Pub. Date: Nov. 30, 2006

(54) Transparent address translation methods

(76) Inventors: Hui-Kai Chang, Douliau City (TW); Cong-Yu Xu, Puli Township (TW); Hung-Chih Chan, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/261,414

(22) Filed: Oct. 28, 2005

(30) Foreign Application Priority Data
Oct. 29, 2004 (TW) 93132970

(51) Int. Cl. H04L 12/56

(52) U.S. Cl. 370/389

(57) ABSTRACT

An address translation method for a LAN (local area network) node using a real Internet protocol (IP) address to deliver and receive transparent application layer packets. First, the IP address of the local node equivalent to the WAN IP address of the router is assigned. Thereafter, the router masquerades ARP responses when the local node looks up MAC addresses of certain destinations, and rewrites the data-link layer header of packets transferred to and from the local node, such that application layer communications are deemed transparent.

### BACKGROUND

The invention relates to an address translation method, in particular, to a transparent application layer translation method and system for use in a local network area (LAN) node using Virtual Internet Protocol (IP) addresses.

IP address occupation grows as the number of computers increases. Thus Network Address Translation (NAT) and Port Address Translation (PAT) are widely used to overcome IP address allocation issues and provide a secure local area network.

NAT is a technique that rewrites packets, such that a plurality of computers each having a virtual IP addresses in local area network can access Internet by one real IP address through a specific router. A router capable of NAT is therefore referred as an IP sharer.

FIG. 1 shows a conventional architecture of a local area network and the Internet. In Internet 100, a remote destination node 102 is provided. The router 104 comprises two interfaces, which is a wide area network (WAN) interface 104a connected to Internet 100, and a local area network (LAN) interface 104b connected to LAN 110. In LAN 110 comprises a plurality of local nodes 106 accessing Internet 100 through the router 104.

Conventionally, packet transfer between two nodes in the same subnet is physically achieved by identifying media access control (MAC) addresses. Conversely, packets are transferred between two nodes in different subnets by routers. Thus, the MAC address of the default gateway (for routing packets in and out) is first identified, and the packets are then physically transferred.

FIG. 2 shows a NAT table 210 and PAT table 220 provided by router 104 based on NAT and PAT standards. The connection session management is implemented through NAT table 210, thereby local nodes can transparently access the Internet via network layer. The PAT table 220 further maps external ports to specific local nodes on specific ports, such that an internal service can be provided over the Internet.

FIG. 3a and FIG. 3b are exemplary flowcharts of conventional PAT. In FIG. 3a, the remote destination node 102 delivers an inbound packet 224. When the inbound packet 224 is routed to router 104, the router 104 looks up a corresponding column in the PAT table 220, and rewrites the inbound packet 224 to inbound packet 222 accordingly. In this example, the destination IP address is rewritten to 192.168.1.4, and the destination port is rewritten to 14662. Thereafter, the inbound packet 222 is transferred to local node 106.

In FIG. 3b, the local node 106 responds an outbound packet 226 destined for the remote destination node 102. When the outbound packet 226 is transferred to router 104, the router 104 rewrites the outbound packet 226 to outbound packet 228 according to the PAT table 220. In the outbound packet 228, the source address is rewritten to 223.82.179.6, and the source port is rewritten to 4662. Thereafter, the outbound packet 228 is transferred to remote destination node 102.

Although NAT and PAT provide Internet access by sharing one IP address, there are some disadvantages. Since NAT and PAT do not rewrite application layer packet headers, when an application encloses its virtual IP address information in the application layer packet header, a connection problem may occur due to an unidentifiable IP address. For example, FTP, IRC, layer 2 tunneling protocol over IP security (L2TP/IPSec) and on-line games typically suffer from this issue.

Many schemes are proposed to alleviate the NAT and PAT bottleneck. Software protocols such as Universal Plug and Play (UPNP) or network address translation traversal (NAT-T), however, require additional application program interface (API) upgrades on corresponding servers, routers and local nodes to accomplish the schemes. Conversely, present commercial products such as layer 7 switches, may provide partial capabilities of application layer rewriting, but only for specific protocols with high cost. Thus a more convenient and efficient solution is desirable.

### SUMMARY

To provide a feasible solution for application layer transparency in local area networks, embodiments of the invention provide an address translation method and system. In the system, a local node in an internal subnet communicates with a destination node, and a router comprises an internal interface for the internal subnet and an external interface for an external subnet. The method comprises the following steps. First, an IP address identical to the IP address of the external interface is bound to the local node. If the destination node is in the external subnet, a masquerading ARP response is generated when the local node queries media access control (MAC) address of the destination node, such that an outbound packet from the local node destined for the destination node can be physically transferred to the router. If the destination node is in neither the internal subnet nor the external subnet, a masqueraded ARP response is generated when the local node queries a MAC address of the external subnet's gateway, such that the outbound packet can be physically transferred to the router.

### DESCRIPTION OF THE DRAWINGS

The following detailed description, given by way of example and not intended to limit the invention solely to the embodiments described herein, will best be understood in conjunction with the accompanying drawings, in which:

FIG. 1 shows a conventional architecture of a local area network and the Internet;

FIG. 2 shows a NAT table 210 and PAT table 220 provided by router 104 based on NAT and PAT standard;

FIG. 3a and FIG. 3b are exemplary flowcharts of conventional PAT;

FIG. 4 shows network architecture according to an embodiment of the invention;

FIG. 5a shows a procedure based on Dynamic Destination node Control Protocol (DHCP);

FIG. 5b shows a procedure based on Address Resolution Protocol (ARP);

FIG. 5c shows the steps of the local node 108 sending a packet to remote destination node 102; and

FIG. 5d shows the steps of the remote destination node 102 sending a packet to local node 108.

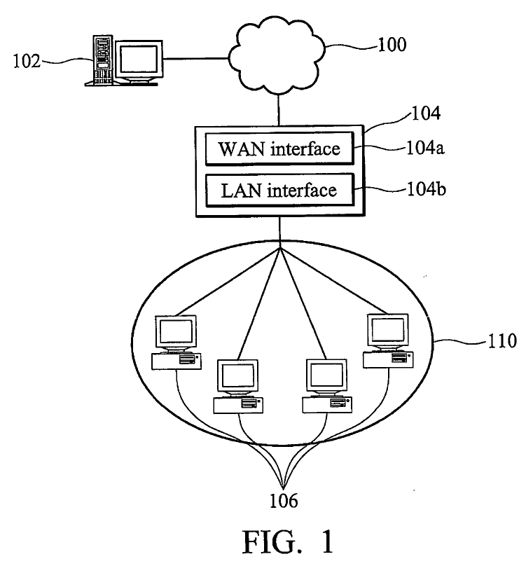

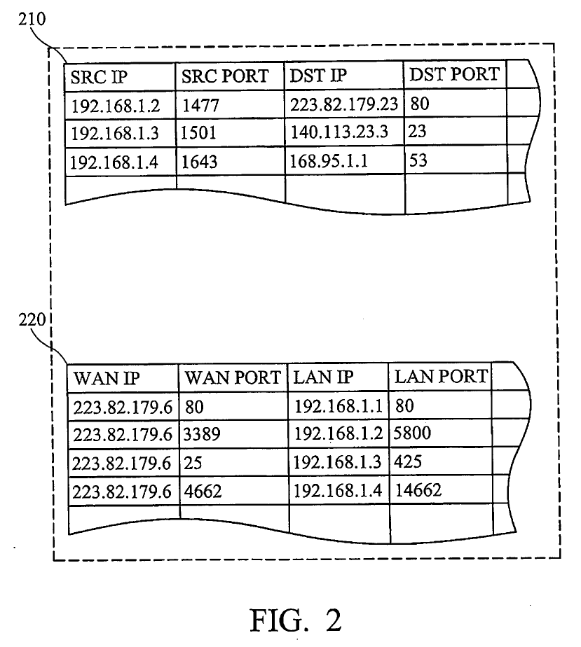

### DETAILED DESCRIPTION

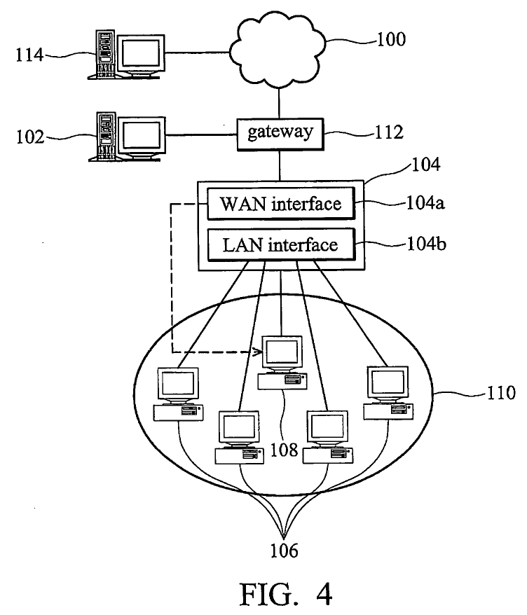

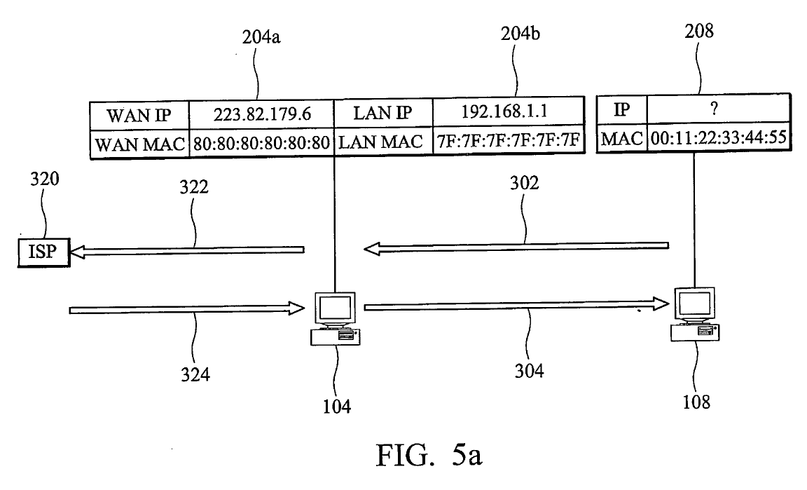

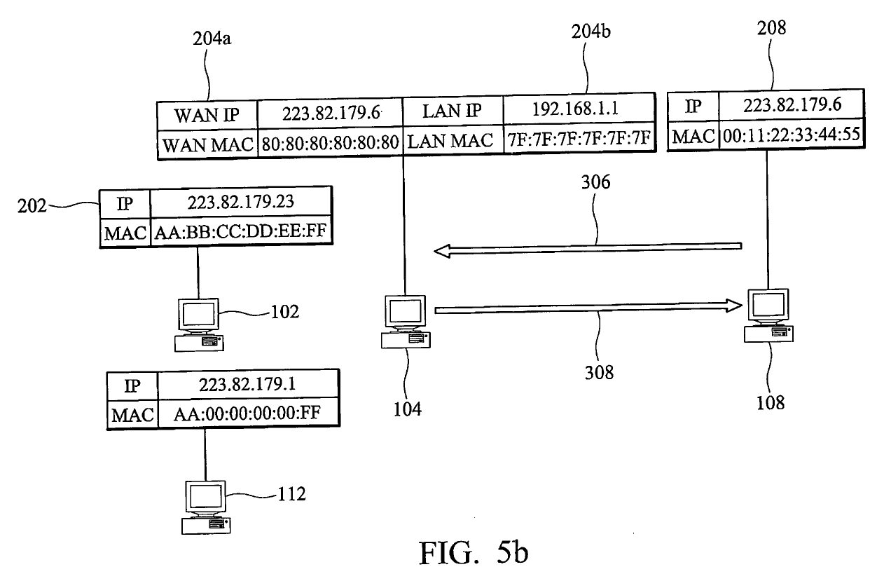

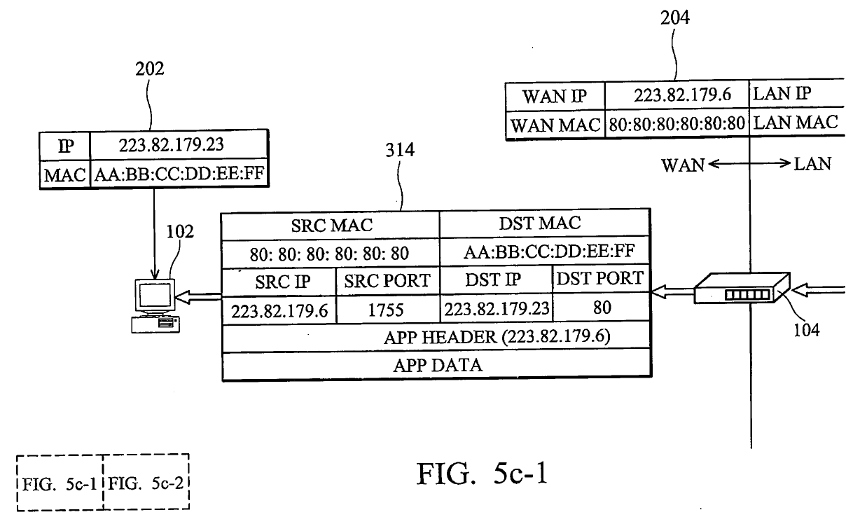

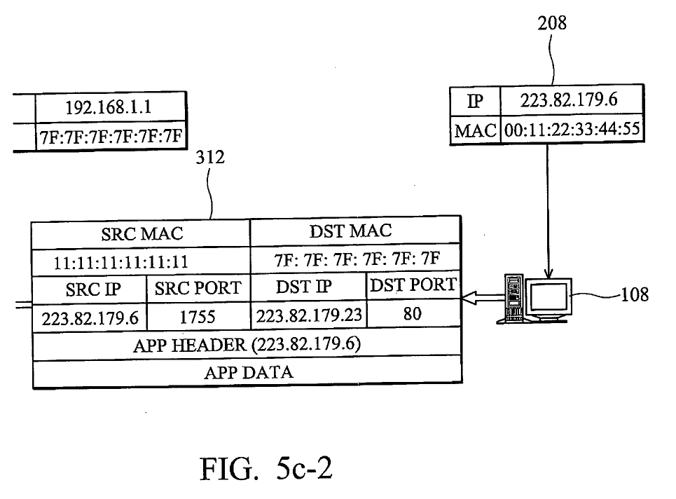

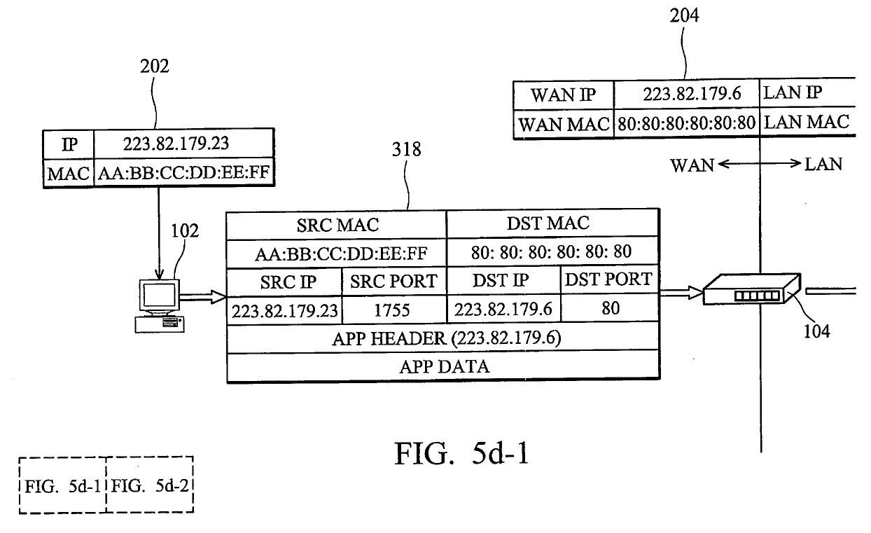

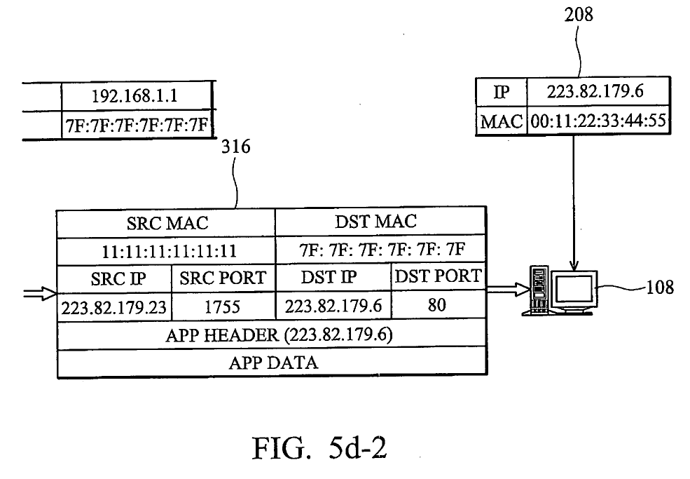

FIG. 4 shows network architecture according to an embodiment of the invention. Remote destination node 102 is a server in the same subnet that the gateway 112 and router 104 are in. Remote destination node 114 is another server in a different subnet from that the gateway 112 is in. The WAN IP address of router 104 is cloned to local node 108, duplicating the IP address. As shown in FIG. 5a, the WAN IP address of router 104 can be obtained from ISP 320 by dynamic destination node control protocol (DHCP). In step 322, the router 104 sends a DHCP request to ISP 320. In step 324, the ISP 320 responds to router 104 with information for configuring WAN interface 204a. Similarly, the router 104 can provide a DHCP service on its LAN interface 104b, and the IP address of local node 108 can be obtained therefrom. In step 304, the local node 108 sends a request to router 104, and in step 304, the router 104 responds to local node 108, assigning the same IP address of the WAN IP of router 104 to the local node 108, 223.82.179.6 in FIG. 5a. When the WAN interface 104a changes dynamically, the IP address of local node 108 is also synchronized. For example, if the WAN interface 104a fails to link to the Internet, instead of assigning the WAN IP address to the local node 108, the router 104 acts as a conventional local area network DHCP server, and the local node 108 acts as a conventional local area network node having a virtual IP address, for example, 192.168.1.2.

As shown in FIG. 4, when a packet from local node 108 is destined for remote destination node 102, it must be received and processed by the router 104 before transfer to remote destination node 102. According to the Open Standard Interface (OSI) specification, packet transfer in the same subnet is accomplished by physical layer identification of a Media Access Control (MAC) address. In this case, in order for packets from local node 108 to be received by the LAN interface 104b of router 104 for further processing, the local node 108 queries the MAC address of the destination remote destination node 102, for example, by the way of conventional Address Resolution Protocol, ARP, and the router 104 responds with the MAC address of LAN interface 104b. Thus packets from local node 108 destined for remote destination node 102 are physically transferred to router 104, and the router 104 transfers the packets to remote destination node 102 directly by physical layer identification.

In another example, when a packet from local node 108 is destined for remote destination node 114 within a subnet different from WAN interface 104a, the packets are physically destined for gateway 112 for further routing. The router 104 must first receive the packet and reroute it to gateway 112. Similarly, in order for packets from local node 108 to be received by the LAN interface 104b of router 104 for further processing, the local node 108 queries the MAC address of the destination gateway 112 (AA:00:00:00:00:FF in FIG. 5b), the router 104 responds with the MAC address of LAN interface 104b (7F:7F:7F:7F:7F:7F in FIG. 5b) Thus packets from local node 108 destined for remote destination node 114 are physically transferred to router 104, and by physical layer identification. The packets can then be transferred to gateway 112 and routed toward remote destination node 114.

FIG. 5b shows the procedure based on ARP. In step 306, an ARP request is first broadcasted, and in step 308, upon receiving the request, the router 104 responds a packet to the local node 18, wherein address provided in the response to this ARP request is actually MAC address 7F:7F:7F:7F:7F:7of LAN interface 204b. The local node 108 accordingly fills the destination MAC address in outbound packets with 7F:7F:7F:7F:7F:7F, such that the router 104 physically receives all the packets.

FIG. 5c shows the steps of the local node 108 sending a packet to remote destination node 102. The local node 108 fills the destination MAC address of the outbound packet 312 with the MAC address of LAN interface 104b, 7F:7F:7F:7F:7F:7F. Thus the router 104 receives the outbound packet 312 and rewrites the source and destination MAC addresses for further transmission. In some embodiments, the source MAC address in the rewritten outbound packet 314 is the MAC address of the WAN interface 104a, 80:80:80:80:80:80, and the destination MAC address is MAC address of the remote destination node 102, AA:BB:CC:DD:EE:FF.

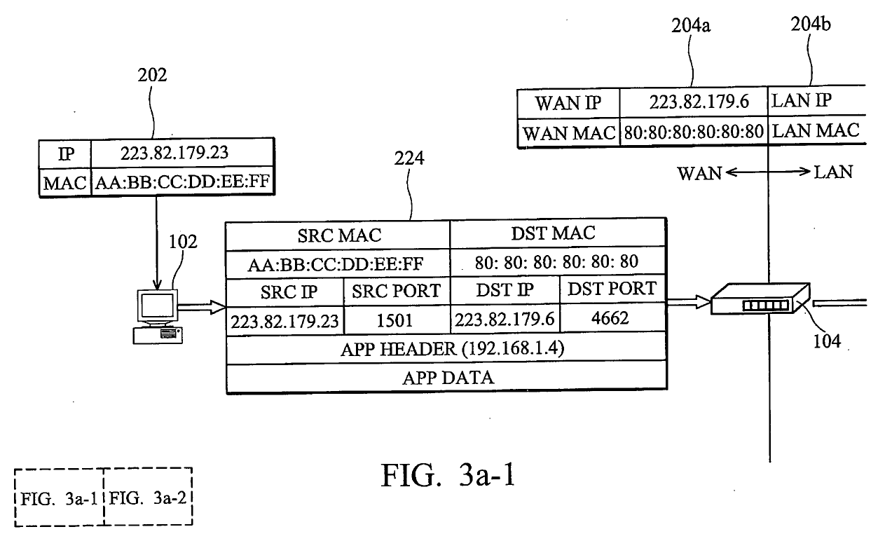

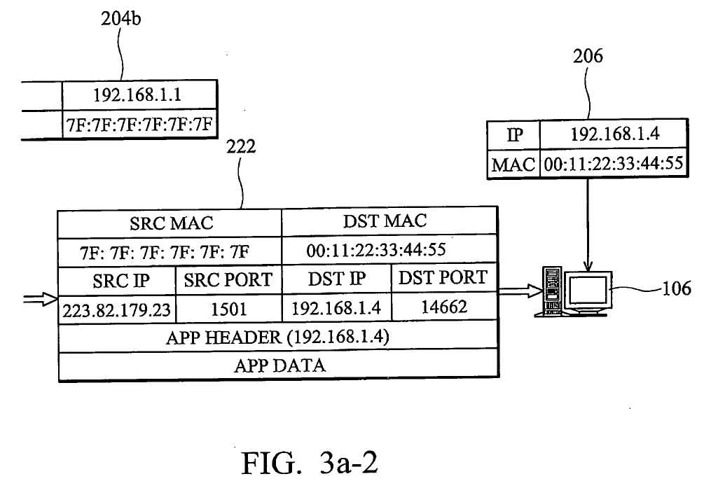

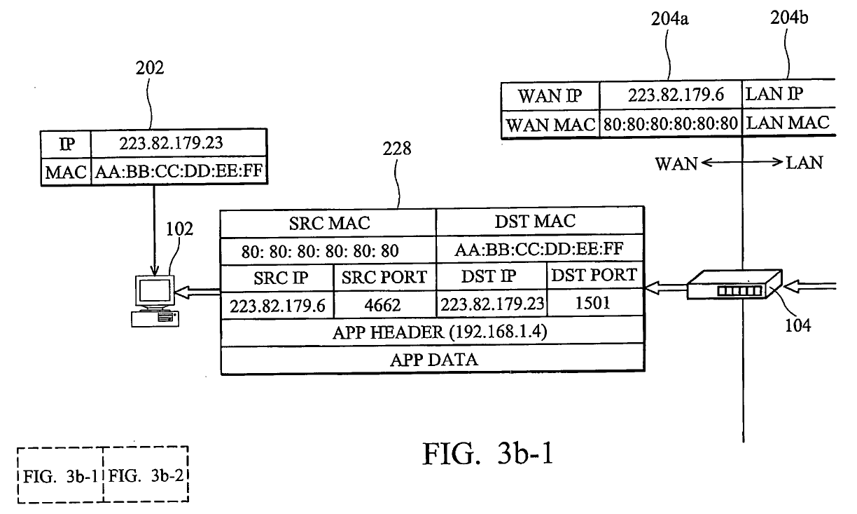

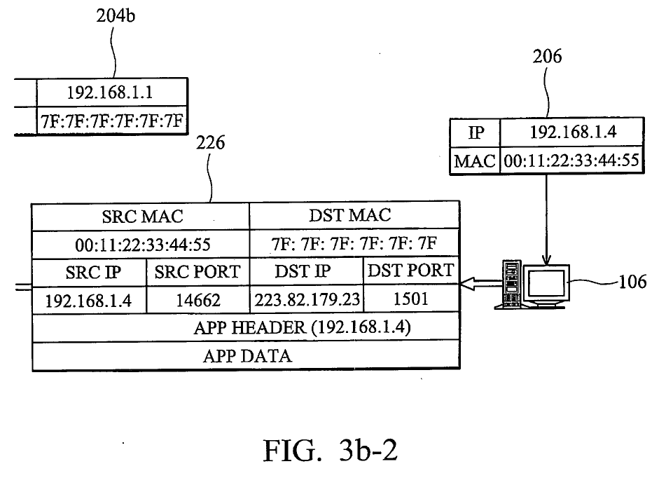

FIG. 5d shows the steps of the remote destination node 102 sending a packet to local node 108. Before the router 104 reroutes the inbound packet 318, a verification sequence must be processed as router 104 may comprise several services, each occupying certain sessions and ports, such as NAT table 210 and PAT table 220 in FIG. 3. When the packet type does not correspond to any other services in the router 104, it is rewritten to inbound packet 316 and sent to local node 108.

Variations can be implemented for further applications. For example, the WAN interface 104a of router 104 can access ISP 320 using Point to Point Protocol over Ethernet (PPPoE) or Serial Line Internet Protocol (SLIP). In the same subnet, packets from local node 106 and local node 108 are processed in the router 104 using different schemes, therefore it is necessary to distinguish which node is associated with the packet. One solution is to provide a non-volatile memory in router 104, to store the MAC address of local node 108, thereby whether a packet is associated with local node 108 can be determined.

In summary, some embodiment of invention accomplish transparency by binding a real IP address to a destination node in local area network and using the router as an ARP proxy to route every packet to and from the destination node.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An address translation method for a local area network comprising a local node and a router, wherein the router comprises an external interface coupled to an external subnet, and an internal interface coupled to the local area network; the method comprising the following steps:
assigning the local node an IP address identical to the IP address of the external interface; and
generating a response based on the MAC address of the internal interface when the local node queries a MAC address of a destination node in the external subnet, such that an outbound packet from the local node destined for the destination node can be physically transferred via the router.

2. The address translation method as claimed in claim 1, the external subnet further comprising a gateway bridging to the internet, the method further comprising: generating a response when the local node queries a MAC address of the gateway, such that the outbound packet can be physically transferred via the router.

3. The address translation method as claimed in claim 1, further comprising recording the MAC address of the local node in the router.

4. The address translation method as claimed in claim 3, further comprising when an inbound packet destined for the external interface is received from the internet:
checking if the inbound packet meets a condition; and
rewriting the inbound packet according to the MAC address of the local node when the condition is met, such that the inbound packet can be physically transferred to the local node.

5. The method as claimed in claim 4, wherein the condition includes that the inbound packet is not associated with the router applications and other services.

6. The method as claimed in claim 1, wherein the step of binding the IP address is achieved through Dynamic host configuration protocol (DHCP), Bootstrap protocol (BOOTP) or Reverse Address Resolution protocol (RARP).

7. An application layer transparent network system, comprising:
a router, comprising a internal interface connected to an internal subnet and an external interface connected to an external subnet; and
a local node in the internal subnet, wherein IP address of the local node is bound identical to the IP address of the external interface.

8. The system as claimed in claim 7, wherein:
the external subnet comprises a gateway for bridging to the internet; and
the router generates a response based on the MAC address of the internal interface when the local node queries a MAC address of the gateway, such that a packet bound for the internet can be physically transferred via the router.

9. The system as claimed in claim 7, wherein when a packet bound for the local node is received from the internet, the router generates a response based on the MAC address of the local node, such that the inbound packet can be physically transferred to the local node.

10. The system as claimed in claim 7, wherein the local node binds the IP address by DHCP, BOOTP or RARP protocols.

11. The system as claimed in claim 7, wherein the system accesses the Internet through an ADSL incorporating PPPOE or a cable modem incorporating DHCP.
